(19) United States
(12) Patent Application Publication
(10) Pub. No.: US 2023/0242835 A1
(43) Pub. Date: Aug. 3, 2023

(54) OLEAGINOUS MATERIAL EXTRACTION USING ALCOHOL SOLVENT

(71) Applicant: Crown Iron Works Company, Blaine, MN (US)

(72) Inventors: Wade Steven Martinson, Minneapolis, MN (US); Benjamin Wayne Floan, Andover, MN (US); Nicholas Ollila, Blaine, MN (US); Jeff Garritsen, Blaine, MN (US); Austin Nelson, Blaine, MN (US)

(21) Appl. No.: 18/003,533

(22) PCT Filed: Jun. 29, 2021
(86) PCT No.: PCT/US2021/039701

§ 371 Date: Dec. 28, 2022

Related U.S. Application Data
(60) Provisional application No. 63/045,191, filed on Jun. 29, 2020.

(51) Int. Cl. C11B 1/10

(52) U.S. Cl. CPC C11B 1/10

(57) ABSTRACT

An oil extraction process may be performed on an oleaginous feedstock using an alcohol-based solvent, such as ethanol. In some examples, an extraction process involves conveying a material in countercurrent direction with an alcohol-based solvent to generate an extracted material and a miscella. The miscella stream is cooled (14) to form a first solvent-rich layer phase separated from a first oil-rich layer, which is then separated (18) to form a first separated oil-rich stream (100) and a first separated solvent-rich stream (102). In some examples, the first separated solvent-rich stream is recycled back to the extractor and introduced into the extractor at a location (38) different than a location (30) where fresh solvent is introduced into the extractor. Additionally or alternatively, water (103) may be introduced into the separated first oil-rich stream to form a second solvent-rich layer phase separated from a second oil-rich layer, which is then separated (20) to form a second separated oil-rich stream (104).

### CROSS-REFERENCE

This application claims the benefit of U.S. Provisional Patent Application No. 63/045,191, filed Jun. 29, 2020, the entire contents of which are incorporated herein by reference.

### TECHNICAL FIELD

This disclosure relates to solvent extraction and, more particularly to liquid-solvent extraction using an alcohol-based solvent.

### BACKGROUND

A variety of different industries use extractors to extract and recover liquid substances entrained within solids. For example, producers of oil from renewable organic sources use extractors to extract oil from oleaginous matter, such as soybeans, rapeseed, sunflower seed, peanuts, cottonseed, palm kernels, and corn germ. The oleaginous matter is contacted with an organic solvent within the extractor, causing the oil to be extracted from a surrounding cellular structure into the organic solvent. As another example, extractors are used to recover oil from oil sands and other petroleum-rich materials. Typically, the petroleum-rich material is ground into small particles and then passed through an extractor to extract the oil from the solid material into a surrounding organic solvent.

During operation, the selected feedstock is passed through the extractor and contacted with a solvent. The solvent can extract oil out of the feedstock to produce an oil deficient solids discharge and a miscella stream. The miscella stream can contain the solvent used for extraction and oil extracted from the feedstock.

In practice, solvents such as hexane are typically used for extracting oil from oleaginous materials. The oil and/or extracted solid can be used as an intermediate or end product for human and/or animal consumption. While the solvent is removed from the oil and/or extracted solid prior to consumption, consumers are increasingly sensitive about food production processes and standards. Ethanol is alternative solvent to hexane that can be used to separate oil from various oleaginous materials. Ethanol is GRAS (Generally Recognized As Safe), can be produced organically, including from renewable feedstocks, and is already accepted by the consuming public as a component of alcoholic beverages.

### SUMMARY

In general, this disclosure is directed to devices, systems, and techniques, for processing an oil-containing material with an alcohol-based solvent to extract oil from the material. In some examples, a system includes an extractor configured to process an oil-containing feedstock. The extractor receives the oil-containing feedstock and conveys the material from an inlet to an outlet through the extractor. The extractor also receives an alcohol-based solvent at a solvent inlet and conveys the solvent through the extractor to a solvent outlet. The alcohol-based solvent may travel in a countercurrent direction through the extractor from a direction of material travel that the feedstock travels through the extractor. In either case, a concentration of oil in the feedstock may decrease as the feedstock moves through the extractor from the inlet to the outlet. Similarly, the concentration of oil in the solvent may increase as the solvent moves through the extractor from the solvent inlet to the solvent outlet.

In accordance with some implementations of the present disclosure, an extractor system may utilize various hardware configurations and processing techniques specifically facilitated by the use of an alcohol-based solvent. The systems and techniques may leverage the processing characteristics and properties of the alcohol-based solvent to efficiently and economically process an oil-containing feedstock utilizing the solvent. While any suitable alcohol-based solvent can be used in the systems and techniques of the disclosure, in some implementations, ethanol is used as the solvent. The ethanol solvent may be hydrous ethanol or anhydrous ethanol. For example, the solvent may contain greater than 90 weight percent ethanol, such as greater than 95 weight percent ethanol, or greater than 98 weight percent ethanol.

In some examples, an extraction system utilizes an extractor that generates an oil-containing solvent stream called a miscella and an oil-deficient solids stream carrying entrained solvent called a marc. To separate the oil from the solvent in the miscella stream, the miscella stream may be cooled to a temperature effective to cause phase separation between the aqueous solvent and the oil in the stream. The solvent rich layer and the oil-rich layer formed via cooling can then be separated, e.g., using a decanter. This can produce a separated oil-rich stream and a separated solvent rich stream. In some implementations, the separated oil-rich stream may be further processed to remove residual solvent in the stream. For example, a comparatively small amount of water may be added to the stream to promote flocculation and further phase separation between the aqueous and oil components of the stream. Addition of water to the oil stream may generate a second phase separation, forming a solvent rich layer and an oil-rich layer. This oil-rich layer formed via the addition of the water can then be separated, e.g., using a second decanter. If desired, yet further processing on the oil-rich layer so separated may be performed, such as distillation, stripping, or the like.

In addition to or in lieu of performing multiple separation steps on the miscella stream generated by the extractor, an extraction system may include one or more recycle streams to recycle solvent recovered from the miscella stream back to the extractor. For example, after phase separating solvent from the miscella stream using one or more separation (e.g., decanting) steps, the residual oil stream may be thermally separated (e.g., via stripping) to produce a finished oil stream and a thermally separated solvent stream substantially devoid of oil. This thermally separated solvent stream may or may not be combined with a thermally separated solvent stream produced by vaporizing solvent from the solvent-wet processed solid material discharged from the extractor. In either case, the solvent may be recycled to the inlet of the extractor where fresh, makeup solvent is also introduced to the extractor.

In some applications, an extractor system according to disclosure may utilize a solvent recycle stream that recycles solvent from a separator (e.g., decanter) back to the extractor, where the recycled solvent is introduced into the extractor at a location different than the location where fresh (and/or recycled solvent substantially devoid of oil) is recycled back to the extractor. For example, in a multistage extractor, a solvent stream produced from a separator may be recycled back to the extractor and introduced into the extractor at an earlier extraction stage than an extraction stage where fresh solvent is introduced into the extractor. The solvent stream produced from the separator may be recycled back to the extractor and introduced into the extractor at location where a composition of miscella in the extractor is substantially the same as a composition of the first separated solvent-rich stream. Recycling the solvent stream produced by the separator back to the extractor without fully purifying the stream (e.g., performing thermal separation to thermally remove residual oil from the solvent) may provide a more efficient and economical process then purifying the separated stream and recycling the purified solvent back to the fresh solvent inlet.

In one example, a method is described that includes conveying a material to be processed in a conveyance direction through an extractor and conveying a solvent comprising alcohol in a countercurrent direction from the conveyance direction through the extractor, thereby generating an extracted material stream and a miscella stream. The method involves cooling the miscella stream to form a first solvent-rich layer phase separated from a first oil-rich layer phase and separating the first solvent-rich layer from the first oil-rich layer to form a first separated oil-rich stream. The method further involves introducing water into the separated first oil-rich stream to form a second solvent-rich layer phase separated from a second oil-rich layer and separating the second solvent-rich layer from the second oil-rich layer to form a second separated oil-rich stream.

In another example, a method is described that includes conveying a material to be processed in a conveyance direction through an extractor and conveying a solvent comprising alcohol in a countercurrent direction from the conveyance direction through the extractor, thereby generating an extracted material stream and a miscella stream. The method includes cooling the miscella stream to form a first solvent-rich layer phase separated from a first oil-rich layer and separating the first solvent-rich layer from the first oil-rich layer to form a first separated oil-rich stream and a first separated solvent-rich stream. The method further involves recycling the first separated solvent-rich stream back to the extractor and introducing the first separated solvent-rich stream into the extractor at a location different than a location where fresh solvent is introduced into the extractor.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example extractor system according to the disclosure.

FIG. 2 is an illustration of an example extractor configuration that can be used in the system of FIG. 1.

### DETAILED DESCRIPTION

In general, the disclosure relates to liquid-solid extractor systems and processes that enable the extraction of one or more desired products from solid material flows. In some examples, the solid material is processed in a continuous flow extractor that conveys a continuous flow of material from the extractor inlet to the extractor outlet while a solvent is conveyed in a countercurrent direction from a solvent inlet to a solvent outlet. As the solvent is conveyed from the extractor inlet to the extractor outlet, the concentration of extracted liquid relative to solvent increases from a relatively small extract-to-solvent ratio to a comparatively large extract-to-solvent ratio. Similarly, as the solid material is conveyed in the opposing direction, the concentration of extract in the solid feedstock decreases from a comparatively high concentration at the inlet to a comparatively low concentration at the outlet. The amount of time the solid material remains in contact with the solvent within the extractor (which may also be referred to as residence time) can vary, for example depending on the material being processed and the operating characteristics of the extractor, although will typically be within the range of 15 minutes to 3 hours, such as from 1 hour to 2 hours.

The solvent discharged from the extractor, which may be referred to as a miscella, contains extracted components (e.g., oil, carbohydrates, sugars) from the solid feedstock. The solvent-wet solid material discharged from the extractor may be residual solid feedstock having undergone extraction. In some configurations according to the present disclosure, the miscella stream produced from the extractor is processed to separate the solvent present in the miscella stream from the oil present in the miscella stream. In one configuration, for example, the miscella stream is received from the extractor and cooled to a temperature effective to cause liquid-liquid phase separation between the aqueous and oil components of the miscella stream. For example, the miscella stream may be cooled to a temperature low enough to cause liquid-liquid phase separation but high enough to substantially prevent solidification of either the aqueous or oil components in the stream. In either case, the phase-separated aqueous and oil components of the miscella stream can be separated for further processing and/or recycle, as described herein.

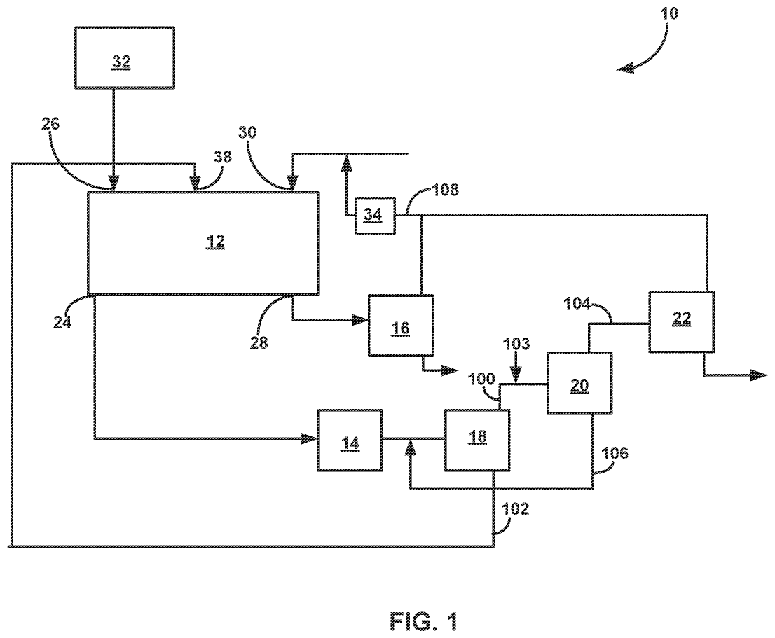

FIG. 1 is a block diagram illustrating an example extraction system 10 according to the disclosure. System 10 includes an extractor 12, a cooling unit 14, and a desolventizer 16. System 10 is also illustrated as a first separator 18 (e.g., decanter), a second separator 20 (e.g., decanter), and a thermal separator 22 (e.g., distillation column, stripping column). Extractor 12 has a feed inlet 26 that can receive a solid material to be subject to extraction within the extractor. Extractor 12 also has a feed outlet 28 that can discharge the solid particulate material after it has undergone extraction and has a lower concentration of extract than the fresh incoming material. Extractor 12 also has a solvent inlet 30 configured to introduce fresh solvent into the extractor and a solvent outlet 24 configured to discharge a miscella formed via extraction of extractable components from the solid material.

In operation, the solid material being processed is contacted with solvent within extractor 12 (e.g., in counter current fashion), causing components soluble within the solvent to be extracted from the solid material into the solvent. Extractor 12 can process any desired solid material using any suitable extraction fluid. Example types of solid material that can be processed using extractor 12 include, but are not limited to, oleaginous matter, such as soybeans, rapeseed, sunflower seed, peanuts, cottonseed, palm kernels, and corn germ; oil-bearing seeds and fruits; asphalt-containing materials (e.g., asphalt-containing roofing shingles that include an aggregate material such as crushed mineral rock, asphalt, and a fiber reinforcing); stimulants (e.g., nicotine, caffeine); alfalfa; almond hulls; anchovy meals; bark; coffee beans and/or grounds, carrots; chicken parts; chlorophyll; diatomic pellets; fish meal; hops; oats; pine needles; tar sands; vanilla; and wood chips and/or pulp.

Alcohol-based solvents that can be used for extraction from solid material include, but are not limited to, mono-hydroxyl or multi-hydroxyl (e.g., di-hydroxyl) alcohols having carbon chains 1 to 8 carbons in length, such as 1 to 4 carbons in length, or 2 to 3 carbons in length. For example, the alcohol-based solvent may be ethanol or isopropyl alcohol. In some examples, the alcohol-based solvent consists essentially of alcohol (e.g., with or without water). For example, the alcohol-based solvent may be a hydrous alcohol or an anhydrous alcohol solvent. In some examples, the alcohol-based solvent has greater than 90 weight percent alcohol and less than 10 weight percent water, such as greater than 95 weight percent alcohol and less than 5 weight percent water, or greater than 98 weight percent alcohol and less than 2 weight percent water.

The feed material supplied to extractor 12 via inlet 26 may be processed before being introduced into the extractor. For example, depending on the material being processed, the material may be dehulled, ground (e.g., size reduced), and/or otherwise prepared for extraction within extractor 12. When using an alcohol-based solvent, the water content of the solid material introduced into the extractor may be controlled to prevent excess water from entering the extractor, which can dilute the solvent and reduce the effectiveness of the extraction.

In the example of FIG. 1, extraction system 10 includes a dryer 32 to dry the solid feed material before the material is introduced into extractor 12. Dryer 32 may dry the material before and/or after size reduction and/or after other preprocessing (when performed). In some examples, dryer 32 is configured to dry the solid material to be processed to a moisture content of 5 weight percent or less, such as 3 weight percent or less, or 2 weight percent or less.

While the material processed using extraction system 10 may undergo preprocessing (e.g., size reduction, drying) prior to being introduced into extractor 12, the material generally will not have undergone a prior stage of extraction. In other words, the material introduced into extractor 12 may be an unextracted material not having been exposed to a solvent prior to being contacted with solvent in extractor 12. As a result, the material being processed in extractor 12 may be a full fat material (e.g., containing the same amount of fat present in the native plant/material being processed) and not a de-fatted material having undergone prior solvent extraction and fat removal.

Extractor 12 can produce a solvent-wet solids stream that discharges through feed outlet 28. To recover solvent from the solvent-wet solids steam and further prepare the residual solids material for end use, the solvent-wet solids stream may be desolventized using mechanical and/or thermal desolventization devices. In the example of FIG. 1, system 10 includes a desolventizer 16. Desolventizer 16 can be implemented using one or more stages of mechanical and/or thermal treatment to remove solvent from the solvent-wet solids stream. In some examples, desolventizer 16 heats the solvent-wet solids stream to vaporize solvent from the stream, optionally with injection of steam, to produce a desolventized solid material. It should be appreciated that the term desolventized solid material refers to a material that is comparatively desolventized and does not require complete desolventization or that the material be devoid of solvent. Rather, the material may be desolventized to a practical level effective for downstream use and/or processing. In different examples, desolventizer 16 can be implemented using a distillation column and/or desolventizer-toaster. In either case, the solvent separate from the solvent-wet solids stream via desolventizer 16 can be recycled back to solvent inlet 30 of extractor 12 for reuse.

Extractor 12 can produce a miscella stream that discharges through solvent outlet 24. Because the miscella stream contain solvent intermixed with extracted oil, the miscella stream may be further processed to separate the solvent from the oil. In the example of FIG. 1, system 10 includes a cooling unit 14 that is configured to receive the miscella stream and cool the stream to promote liquid-liquid phase separation between the aqueous alcohol-based solvent component of the miscella and the extracted oil component of the miscella. Cooling unit 14 may be implemented using one or more heat exchangers or other thermal transfer devices that reduce a temperature of the miscella stream to a temperature effective to cause phase separation. In some examples, cooling unit 14 cools the miscella stream to a temperature less than 40 degrees Celsius, such as less than 30 degrees Celsius, or less than 25 degrees Celsius (e.g., a temperature ranging from 15 degrees Celsius to 25 degrees Celsius, such as approximately 20 degrees Celsius).

By contrast, the operating temperature of extractor 12 may be sufficiently hot to produce a miscella stream discharging from the extractor at a temperature greater than 50 degrees Celsius, such as greater than 60 degrees Celsius, or greater than 65 degrees Celsius. For example, the temperature of the miscella stream received from the extractor may range from 60 degrees Celsius to 90 degrees Celsius, such as from 65 degrees Celsius to 80 degrees Celsius, such as approximately 70 degrees Celsius.

Cooling the miscella stream can produce a first solvent rich layer phase separated from a first oil-rich layer. A compositional gradient may exist between the solvent rich layer and the oil-rich layer formed by cooling the miscella stream. In either case, in the example of FIG. 1, extraction system 10 includes a separator 18 to separate the first solvent rich layer from the first oil-rich layer. Separator 18 may be implemented using a decanter (e.g., gravity decanter) and/or other liquid separation device, such as a centrifuge and/or cyclone. Separator 18 can separate the solvent rich layer from the oil-rich layer to produce a separated first oil-rich stream 100 and a separated first solvent rich stream 102. The two separate streams may be recycled and/or further processed.

For example, with reference to FIG. 1, the separated first oil-rich stream 100 may be further processed to remove residual solvent from the stream. In some examples, an amount of water 103 is added to the separated first oil-rich stream 100 to promote further phase separation between the oil component of the stream and residual solvent in the stream. The amount of water added to the separated first oil-rich stream 100 may be comparatively small, such as an amount of water that is less than 10 weight % of a weight of the separated first oil-rich stream 100, such as less than 5 weight %, less than 3 weight %, less than about 1 weight %, less than about 0.5 weight %, less than about 0.2 weight %, or less than about 0.1 weight %. In some examples, mixing equipment such as a static mixer, dynamic mixer, and/or homogenizer may be used to facilitate mass transfer between the phases and promote further phase separation.

Adding an amount of water to the first separated oil rich stream 100 can cause further liquid-liquid phase separation between the oil component in the stream and the residual solvent in the stream. This can form a second solvent rich layer phase separated from a second oil-rich layer. A compositional gradient may exist between the solvent rich layer and the oil-rich layer formed by adding water to the first separated oil-rich stream. In either case, in the example of FIG. 1, extraction system 10 includes a second separator 20 to separate the second solvent rich layer from the second oil-rich layer. Separator 20 may be implemented using a decanter (e.g., gravity decanter) and/or other liquid separation device, such as a centrifuge and/or cyclone. Separator 20 can separate the solvent rich layer from the oil-rich layer to produce a separated second oil-rich stream 104 and a separated second solvent rich stream 106. The two separate streams may be recycled and/or further processed.

Reference to an “solvent-rich stream” in the present disclosure means that the referenced stream contains a greater amount of solvent than the remaining components of the stream, such as at least 50 wt % solvent (based on the weight of solvent in the stream divided by the total weight of the stream), such as at least 60 wt % solvent, at least 70 wt % solvent, at least 80 wt % solvent, at least 90 wt % solvent, or at least 95 wt % solvent. Further, reference to an “oil-rich stream” in the present disclosure means that the referenced stream contains a greater amount of oil than the remaining components of the stream, such as at least 50 wt % oil (based on the weight of oil in the stream divided by the total weight of the stream), such as at least 60 wt % oil, at least 70 wt % oil, at least 80 wt % oil, at least 90 wt % oil, or at least 95 wt % oil. In practice, the actual composition of the stream may vary over time, e.g., do the changing feedstock compositions, operating conditions, and the like.

In the example of FIG. 1, the separated second oil-rich stream 104 is it conveyed to a thermal separator 22 to remove residual solvent from the second oil-rich stream 104. Thermal separator 22 can be implemented using a stripping column (e.g., that utilizes steam or other motive gas), a distillation column, a flash drum, and/or other thermal separation device. In either case, the solvent separated from the separated second oil-rich stream 104 via thermal separator 22 can be recycled back to solvent inlet 30 of extractor 12 for reuse.

The solvent separated from second oil-rich stream 104 via thermal separator 22 can be combined with solvent recovered by desolventizer 16 and the combined solvent stream 108 recycled back to solvent inlet 30. In some implementations, one or both streams are further processed in a dewatering unit 34 to remove residual water from the substantially oil-free solvent recycle streams generated by desolventizer 16 and/or thermal separator 22. In different examples, dewatering unit 34 may be implemented using one or more of a molecular sieve, a pervaporation membrane, a vapor permeation membrane, and/or a biomass adsorption system. Dewatering unit 34 may remove only a portion of the water present in the solvent stream or substantially all of the water present in the solvent stream being processed. For example, dewatering unit 34 may remove at least 25 wt % of the water present in the incoming stream being processed by the unit, such as at least 50 wt %, at least 70 wt %, at least 80 wt %, at least 90 wt %, at least 95 wt %, or at least 98 wt %.

The second solvent rich stream 106 produced by separator 20 can be recycled to extractor 12 and/or reused to help process the upstream miscella stream. For example, the second solvent rich stream 106 may be recycled and mixed with the miscella steam after extractor 12 and upstream of separator 18 prior to cooling the miscella stream, while cooling the miscella stream, and/or after cooling the miscella stream. Residual moisture in the recycled second solvent rich stream 106 may help promote phase separation prior to separator 18.

The first separated solvent rich stream 102 produced by separator 18 can be recycled back to extractor 12. In different examples, first separated solvent rich stream 102 can be recycled to inlet 30 of extractor 12 or to a location different than a location where fresh solvent is introduced into the extractor, which can be referred to as a second or recycle solvent inlet 38. For example, first separated solvent rich stream 102 may be recycled to extractor 12 and introduced into the extractor at an earlier extraction stage than an extraction stage where fresh solvent is introduced into the extractor. For example, the first separated solvent rich stream 102 may be recycled back to extractor 12 and introduced into the extractor at a location where a composition of miscella in the extractor is substantially the same as a composition of the first separated solvent-rich stream. For example, the concentration of the solvent in the first separated solvent rich stream 102 (e.g., calculated by dividing the weight of the alcohol and water by the combined weight of the alcohol, water, and oil) may be within ±20 weight percent of the concentration of the solvent in the miscella in the extraction stage of the extractor to which the separated solvent stream is recycled, such as within ±10 weight percent, or within ±5 weight percent. Additionally or alternatively, the concentration of the oil in the first separated solvent rich stream 102 (e.g., calculated by dividing the weight of the oil by the combined weight of the alcohol, water, and oil) may be within ±20 weight percent of the concentration of the oil in the miscella in the extraction stage of the extractor to which the separated solvent stream is recycled, such as within ±10 weight percent, or within ±5 weight percent.

In some examples, first separated solvent rich stream 102 supplied to recycle inlet 38 has an oil content ranging from 2 wt % oil to 10 wt % oil, such as from about 4 wt % oil to about 8 wt % oil. By contrast, fresh solvent supplied to inlet 30 may have an oil content less than 2 wt %, such as less than 1 wt %, less than 0.5 wt %, or less than 0.25 wt %.

The relative amounts of incoming feed to feed inlet 26, fresh solvent to solvent inlet 30, and recycled solvent to a recycle solvent inlet of the extractor can vary depending on the design parameters of the system and extraction objectives. As described herein, reference to fresh solvent includes both new/virgin solvent not previously passed through extractor 12 as well as recovered solvent processed through thermal separator 22 and recycled to solvent inlet 30 (e.g., that is compositionally similar to virgin solvent). Recycled solvent generally refers to solvent (e.g., first separated solvent rich stream 102) provided to a different solvent inlet than inlet 30 and that is compositionally dissimilar from solvent delivered to inlet 30 (e.g., because the recycled solvent has a higher oil and/or water content than the solvent supplied to inlet 30).

Operational values for relative flow rates may reflect tradeoffs made for different applications. For example, embodiments of the process may independently set one or more solvent:feed ratios (the ratio of the mass flow of solvent to the mass flow of solid feed material) for the separated solvent and for the fresh solvent. Minimizing these ratios can reduce the size and energy requirements of phase separation and solvent recovery equipment, while increasing the size of the extraction equipment. Higher ratios also reduce the impact of water transfer between solid and liquid phases on the solvent composition. Solvent ratio and extractor size may be traded against each other to produce a given residual oil content in the meal after extraction.

Similarly, extraction may be performed at a range of different temperatures. Higher temperatures generally reduce the size of the extraction equipment, while increasing the energy required. Temperature may limit the solubility of oil in the solvent. Solvent ratios may need to be increased as the solubility limit drops. Furthermore, different operating temperatures may produce changes in the product characteristics, including, but not limited, meal flavor and color profile, protein solubility, and degree of extraction of non-primary components from the feed material. Phase separation may be performed at a range of different temperatures. Higher temperatures generally reduce the energy required for cooling, while reducing the purity of the two phases at equilibrium.

In one example application, the user may target low residual oil in the extracted solid material and allow higher temperature extraction. For this application driven primarily by oil recovery, extraction may be performed at an extractor temperature between 65 C and 75 C, or between 68 C and 74 C, or between 70 C and 73 C. The fresh solvent ratio (weight of incoming fresh solvent to inlet 30 divided by weight of the incoming solid material to feed inlet 26) may be set between 0.4 and 1.0, or between 0.5 and 0.8. The separated solvent ratio (weight of recycled solvent to the recycle inlet divided by the weight of the incoming solid material to feed inlet 26) may be set between 0.8 and 1.8, or between 0.9 and 1.5, or between 1.0 and 1.2.

In another example application, the user may target lower residual oil in the extracted solid material and use a lower extraction temperature. This may be a human food application, e.g., where particular product attributes such as flavor profile, color, and/or protein solubility are enhanced at a lower extraction temperature. For this application, extraction may be performed at a temperature that brings the oil solubility limit to approximately 12 wt % in the miscella, but still provided low residual oil in the extracted meal. This design may utilize a fresh solvent ratio between 1.1 and 1.6, or between 1.2 and 1.5. With a phase split system that returns separated solvent at approximately 8 wt % oil, the separated solvent ratio may be set between 3.0 and 5.0, or between 3.25 and 4.0. Alternatively, with a phase split system that returns separated solvent at approximately 4% oil, the separated solvent ratio may be set between 1.5 and 3.0, or between 1.75 and 2.0.

In another example application, the user may target a reduced extractor size with the tradeoff of higher energy costs. In this application, the design may utilize a fresh solvent ratio between 1.5 and 2.5, or between 1.75 and 2.0. The separated solvent ratio may be set between 3.0 and 6.0, or between 4.0 and 5.0.

In another example application, the user may target higher residual oil in the extracted material and utilize a lower extraction temperature. For this application, extraction may be performed at an extractor temperature that limits the oil solubility to approximately 12 wt % in the miscella but allows an approximately 8 wt % residual oil content in the extracted meal. The design may operate with a fresh solvent ratio between 0.75 and 1.0, or between 0.8 and 0.9. With a phase split system that returns separated solvent at approximately 8% oil, the separated solvent ratio may be set between 2.5 and 4.0, or between 2.75 and 3.0. Alternatively, with a phase split system that returns separated solvent at approximately 4 wt % oil, the separated solvent ratio may be set between 1.25 and 3.0, or between 1.5 and 2.0.

Extractor 12 can be implemented using any suitable type of extractor configuration. For example, extractor 12 may be an immersion extractor, a percolation extractor, or yet other type of extractor design. In one example, extractor 12 is a shallow bed continuous loop extractor.

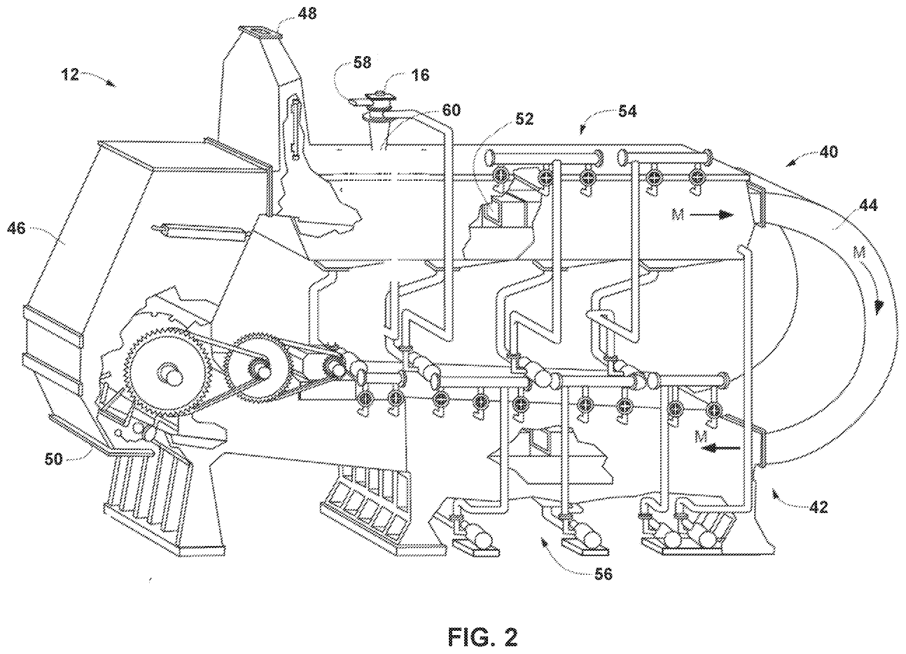

FIG. 2 is an illustration of an example extractor configuration that can be used for extractor 12. In the example shown, extractor 12 includes a housing defining a passageway in the form of a loop disposed in a vertical plane. The extractor can include upper and lower extraction sections 40, 42 each with a series of extraction chambers, a generally arcuate hollow transfer section 44 having its opposite upper and lower ends connected to first ends of the upper and lower extraction sections respectively, and a hollow, generally vertical return section 46 connected at its upper and lower ends respectively to the other ends of the upper and lower extraction sections. The upper extraction section can include an inlet portion 48 for delivery of solid material to the interior thereof in closely spaced relation to the upper end of the return section, and the lower end of the return section can define an opening 50 for discharge of the material after the product-of-interest has been extracted therefrom. The number of extraction chambers, or stages, provided by the extractor can vary depending on the desired sized of the extractor. The extractor includes at least one extraction chamber, or stage, and typically includes multiple stages (e.g., 6 stages, 8 stages, or more). A Model III extractor commercially available from Crown Iron Works Company of Minneapolis, Minn., is a specific example of an extractor of this type.

In such an extractor, a conveyor system 52 can extend longitudinally through the looped passageway and be driven in a material flow direction “M” to move the material as a bed from the inlet portion 48 through the upper extraction section 40 toward and downwardly through the transfer section 44, and through the lower extraction section 42 toward the lower end of the return section and the discharge opening 50. In some embodiments, the conveyor system includes a pair of laterally spaced endless link chains and a plurality of longitudinally spaced flights that extend transversely of the chains. A motor and gearing may be provided to drive the conveyor.

In some configurations, a fluid supply system 54 can be disposed above the solid materials and configured to apply a fluid to the solid materials in each extraction chamber, and a fluid removal system 56 can be disposed below the solid materials and configured for removing the fluid after it has passed through the solid materials in each extraction chamber. In some embodiments, the fluid supply system and the fluid removal system are in fluid communication via various recycle streams and the like. The fluid supply system may include a network of spray headers, pumps, and pipes to apply the fluid in each extraction chamber. The fluid supply system can apply (e.g., spray) the extraction fluid on top of the conveyed solid material, allowing the extraction fluid to then percolate through the material. The fluid removal system may include a network of drains, pumps, and pipes to collect the fluid after it has percolated through the solid material in each extraction chamber and deliver it to the fluid supply system of another extraction chamber or remove it from the system.

As shown in FIG. 2, fluid having passed through the solid material is collected by the fluid removal system 56 and delivered to separation device 16, which in the illustrated example is shown as a cyclone-type separator to separate any solid fines from the fluid before fluid discharge. An outlet conduit 58 of separation device 16 can deliver the fluid, generally a mixture of extraction fluid and soluble components extracted from the solid material into the extraction fluid (e.g., oil when processing oil seed) (commonly known as “miscella”), to other equipment, not shown, for separating the extraction fluid from the material extracted from the solid material being processed. A separate outlet 60 of separation device 16 can deliver a stream containing particulate matter separated from the miscella for further processing, as described herein.

As material is conveyed through first extractor 12, spray headers from the fluid supply system 54 spray recycled extraction fluid on the top of the material. The material percolates through the material and through the screen, where it is collected in the network of drain pipes and delivered back to the network of spray headers where it is reapplied to the solid material in a different extraction chamber. In some embodiments, fresh extraction fluid is applied to the material in the last extraction chamber before the solid material discharge 50. For example, fresh extraction fluid may be applied to the material in the last extraction chamber before discharge 50 and, after being collected at the bottom of the chamber, recycled and applied on top of solid material in an adjacent upstream extraction chamber. By recycling collected extraction fluid from one extraction chamber to an adjacent upstream extraction chamber, liquid extraction fluid and solid material being processed can move in countercurrent directions through the extractor. For example, as extraction fluid is conveyed sequentially through adjacent extraction chambers between a fresh extraction fluid inlet adjacent discharge 50 and an enriched extraction fluid outlet adjacent inlet 48, the concentration of extract relative to extraction fluid increases from a relatively small extract-to-extraction fluid ratio to a comparatively large extract-to-extraction fluid ratio. Similarly, as the solid material is conveyed in the opposing direction, the concentration of extract in the solid feedstock decreases from a comparatively high concentration at the inlet 48 to a comparatively low concentration at the outlet 60.

An alcohol-based solvent extraction process according to the present disclosure may provide various advantages over an extraction process that does not use an alcohol-based solvent. For example, an alcohol-based solvent may provide better compatibility with food supply chains. Ethanol is GRAS (Generally Recognized As Safe), can be produced organically from renewable feedstocks, and is already consumed directly as a component of alcoholic beverages. As another example, an alcohol-based solvent may improve the processed product attributes of some feedstocks. When applied to soybean flakes, for instance, an alcohol-based solvent may produce a meal with less “beany” flavor and less color. When applied to either soybean flakes or cottonseed meats, an alcohol-based solvent may alter protein solubility and lowers antinutritional factor content. The alcohol-based solvent may produce an oil with lower wax and phosphatide content.

Various examples have been described. These and other examples are within the scope of the following claims.

1. A method comprising:
conveying a material to be processed in a conveyance direction through an extractor and conveying a solvent comprising alcohol in a countercurrent direction from the conveyance direction through the extractor, thereby generating an extracted material stream and a miscella stream;
cooling the miscella stream to form a first solvent-rich layer phase separated from a first oil-rich layer;
separating the first solvent-rich layer from the first oil-rich layer to form a first separated oil-rich stream and a first separated solvent-rich stream; and
recycling the first separated solvent-rich stream back to the extractor and introducing the first separated solvent-rich stream into the extractor at a location different than a location where fresh solvent is introduced into the extractor.

2. The method of claim 1, wherein introducing the first separated solvent-rich stream into the extractor at a location different than a location where fresh solvent is introduced into the extractor comprises introducing the first separated solvent-rich stream into the extractor at an earlier extraction stage than an extraction stage where fresh solvent is introduced into the extractor.

3. The method of claim 1, wherein introducing the first separated solvent-rich stream into the extractor at a location different than a location where fresh solvent is introduced into extractor comprises introducing the first separated solvent-rich stream into the extractor at location where a composition of miscella in the extractor is substantially the same as a composition of the first separated solvent-rich stream.

4. The method of claim 1, wherein introducing the first separated solvent-rich stream into the extractor at a location different than a location where fresh solvent is introduced into extractor comprises introducing the first separated solvent-rich stream into the extractor at location where a concentration of oil in a miscella in the extractor is ±20 weight percent of the concentration of the oil in the first separated solvent-rich stream.

5. The method of claim 1, wherein introducing the first separated solvent-rich stream into the extractor at a location different than a location where fresh solvent is introduced into extractor comprises introducing the first separated solvent-rich stream into the extractor at location where a concentration of solvent in a miscella in the extractor is ±10 weight percent.

6. (canceled)

7. The method of claim 1, wherein a weight of fresh solvent supplied to a fresh solvent inlet of the extractor divided by a weight of the material supplied to a feed inlet of the extractor defines a fresh solvent ratio, and the fresh solvent ratio is within a range from 0.6 to 2.5.

8. (canceled)

9. The method of claim 1, wherein a weight of recycled solvent supplied to a recycled solvent inlet of the extractor divided by a weight of the material supplied to a feed inlet of the extractor defines a separated solvent ratio, and the separated solvent ratio is within a range from 0.3 to 1.5.

10. The method of claim 1, wherein separating the first solvent-rich layer from the first oil-rich layer to form the first separated oil-rich stream and the first separated solvent-rich stream comprises decanting the first oil-rich layer from the first solvent-rich layer.

11. The method of claim 1, wherein cooling the miscella stream to form the first solvent-rich layer phase separated from the first oil-rich layer comprises cooling the miscella stream to a temperature less than 40 degrees Celsius.

12. (canceled)

13. The method of claim 1, further comprising:
introducing water into the separated first oil-rich stream to form a second solvent-rich layer phase separated from a second oil-rich layer; and
separating the second solvent-rich layer from the second oil-rich layer to form a second separated oil-rich stream and a second separated solvent-rich stream.

14. (canceled)

15. The method of claim 13, further comprising conveying the second separated oil-rich stream to a thermal separator and thermally separating residual solvent in the second separated oil-rich stream from oil.

16. The method of claim 15, further comprising dewatering the residual solvent thermally separated from the second separated oil-rich stream from oil by a dewatering device to produce a dewatered solvent, and conveying at least a portion of the dewatered solvent to a fresh solvent inlet of the extractor.

17. (canceled)

18. The method of claim 1, wherein the alcohol comprises ethanol.

19. The method of claim 18, wherein the solvent comprises greater than 98 weight percent ethanol and less than 2 weight percent water.

20. The method of claim 1, further comprising conveying the extracted material stream to a desolventizer and desolventizing the extracted material in the dryer, wherein the desolventizer produces a separated solvent stream, and further comprising dewatering the separated solvent stream by a dewatering device to produce a dewatered solvent, and conveying at least a portion of the dewatered solvent to a fresh solvent inlet of the extractor.

21. (canceled)

22. (canceled)

23. The method claim 1, wherein the material has not previously been solvent extracted prior to being introduced into the extractor.

24. The method of claim 1, further comprising, prior to conveying the material to be processed in the conveyance direction through the extractor, drying the material to be processed, wherein drying the material to be processed comprises drying the material to be processed to a moisture content of 5 weight percent or less.

25-28. (canceled)

29. A method comprising:
conveying a material to be processed in a conveyance direction through an extractor and conveying a solvent comprising alcohol in a countercurrent direction from the conveyance direction through the extractor, thereby generating an extracted material stream and a miscella stream;
cooling the miscella stream to form a first solvent-rich layer phase separated from a first oil-rich layer;
separating the first solvent-rich layer from the first oil-rich layer to form a first separated oil-rich stream;
introducing water into the separated first oil-rich stream to form a second solvent-rich layer phase separated from a second oil-rich layer; and
separating the second solvent-rich layer from the second oil-rich layer to form a second separated oil-rich stream.

30. The method of claim 29, wherein cooling the miscella stream to form the first solvent-rich layer phase separated from the first oil-rich layer comprises cooling the miscella stream to a temperature less than 40 degrees Celsius.

31. (canceled)

32. The method of claim 29, wherein separating the first solvent-rich layer from the first oil-rich layer to form the first separated oil-rich stream comprises decanting the first oil-rich layer from the first solvent-rich layer.

33. The method of claim 29, wherein introducing water into the separated first oil-rich stream comprises introducing an amount of water that is less than 10 weight % of a weight of the separated first oil-rich stream.

34. (canceled)

35. The method of claim 29, wherein the alcohol comprises ethanol.

36. (canceled)

37. The method of claim 29, further comprising conveying the second separated oil-rich stream to a thermal separator, thermally separating residual solvent in the second separated oil-rich stream from oil, dewatering the residual solvent thermally separated from the second separated oil-rich stream from oil by a dewatering device to produce a dewatered solvent, and conveying at least a portion of the dewatered solvent to a fresh solvent inlet of the extractor.

38-42. (canceled)

43. The method of claim 29, wherein separating the second solvent-rich layer from the second oil-rich layer to form the second separated oil-rich stream comprises forming a second separated solvent-rich stream, and further comprising recycling the second separated solvent-rich stream and mixing the second separated solvent-rich stream with the miscella stream at least one of prior to cooling the miscella stream, while cooling the miscella stream, or after cooling the miscella stream.

44. The method of claim 29, wherein separating the first solvent-rich layer from the first oil-rich layer to form the first separated oil-rich stream comprises forming a first separated solvent-rich stream, and further comprising recycling the first separated solvent-rich stream back to the extractor.

45. The method of claim 44, wherein recycling the first separated solvent-rich stream back to the extractor comprises introducing the first separated solvent-rich stream into the extractor at a location different than a location where fresh solvent is introduced into the extractor.

46-49. (canceled)
